(19) United States
(12) Patent Application Publication
(10) Pub. No.: US 2017/0370232 A1
(43) Pub. Date: Dec. 28, 2017

(54) TURBINE AIRFOIL COOLING SYSTEM WITH CHORDWISE EXTENDING SQUEALER TIP COOLING CHANNEL

(71) Applicant: Siemens Energy, Inc., Orlando, FL (US)

(72) Inventor: Ching-Pang Lee, Cincinnati, OH (US)

(21) Appl. No.: 15/544,112

(22) PCT Filed: Jan. 22, 2015
(86) PCT No.: PCT/US2015/012365

§ 371 Date: Jul. 17, 2017

(51) Int. Cl. F01D 5/18

(52) U.S. Cl. CPC F01D 5/187; F05D 2260/2212; F05D 2220/32; F05D 2240/307; F05D 2260/202

(57) ABSTRACT

An internal cooling system (10) for an airfoil (12) in a turbine engine (14) whereby the cooling system (10) includes a chordwise extending tip cooling channel (16) radially inward of a squealer tip (18) and formed at least in part by an inner wall (20) with a nonlinear outer surface (22) is disclosed. The nonlinear outer surface (22) of the inner wall (20) of the chordwise extending tip cooling channel (16) may be formed from pressure and suction side sections (24, 26) that intersect at a point (74) that is closer to the inner surface (30) of an outer wall (32) forming at least a portion of the squealer tip (18) than other aspects of the pressure side section (24) and the suction side section (26). The configurations of the pressure and suction side sections (24, 26) reduces the flow cross-sectional area, which accelerates the cooling fluid flow in a chordwise direction within the chordwise extending tip cooling channel (16) and directs cooling fluid toward the pressure and suction side outer walls (34, 36) for improved cooling efficiency.

### STATEMENT REGARDING FEDERALLY SPONSORED RESEARCH OR DEVELOPMENT

Development of this invention was supported in part by the United States Department of Energy, Advanced Turbine Development Program, Contract No. DE-FC26-05NT42644. Accordingly, the United States Government may have certain rights in this invention.

### FIELD OF THE INVENTION

This invention is directed generally to turbine blades, and more particularly to cooling systems at airfoil tips for turbine blades.

### BACKGROUND

Typically, gas turbine engines include a compressor for compressing air, a combustor for mixing the compressed air with fuel and igniting the mixture, and a turbine blade assembly for producing power. Combustors often operate at high temperatures that may exceed 2,500 degrees Fahrenheit. Typical turbine combustor configurations expose turbine blade assemblies to these high temperatures. As a result, turbine blades must be made of materials capable of withstanding such high temperatures.

Typically, turbine blade is formed from a root portion at one end and an elongated portion forming a blade that extends outwardly from a platform coupled to the root portion at an opposite end of the turbine blade. The blade is ordinarily composed of a tip opposite the root section, a leading edge, and a trailing edge. The tip of a turbine blade often has a tip feature to reduce the size of the gap between ring segments and blades in the gas path of the turbine to prevent tip flow leakage, which reduces the amount of torque generated by the turbine blades. The tip features are often referred to as squealer tips and are frequently incorporated onto the tips of blades to help reduce aerodynamic losses in turbine stages. These features are designed to minimize the leakage between the blade tip and the ring segment.

### SUMMARY OF THE INVENTION

An internal cooling system for an airfoil in a turbine engine whereby the cooling system includes a chordwise extending tip cooling channel radially inward of a squealer tip and formed at least in part by an inner wall with a nonlinear outer surface is disclosed. The nonlinear outer surface of the inner wall of the chordwise extending tip cooling channel may be formed from pressure and suction side sections that intersect at a point that is closer to the inner surface of an outer wall forming at least a portion of the squealer tip than other aspects of the pressure side section and the suction side sections. The configurations of the pressure and suction side sections reduces the flow cross-sectional area, which accelerates the cooling fluid flow in a chordwise direction within the chordwise extending tip cooling channel and directs cooling fluid toward the pressure and suction side outer walls for improved cooling efficiency.

In at least one embodiment, the turbine airfoil may include a generally elongated blade having a leading edge, a trailing edge, a squealer tip at a first end, a root coupled to the blade at a second end generally opposite the first end for supporting the blade and for coupling the blade to a disc, and an internal cooling system formed from at least one cavity positioned within the generally elongated blade. The internal cooling system may include one or more chordwise extending tip cooling channels formed at least in part by an inner surface of an outer wall forming at least a portion of the squealer tip. The chordwise extending tip cooling channel may include an inner wall formed from a pressure side section that has an outer surface that is nonparallel and nonorthogonal to an inner surface of a pressure side outer wall, and a suction side section that has an outer surface that is nonparallel and nonorthogonal to an inner surface of a suction side outer wall. The outer surfaces of the pressure side section and the suction side sections forming the inner wall of the chordwise extending tip cooling channel may be nonparallel and nonorthogonal relative to each other. An intersection between the outer surfaces of the pressure side section and the suction side section forming the inner wall of the at least one chordwise extending tip cooling channel may be closer to the inner surface of an outer wall forming at least a portion of the squealer tip than other aspects of the pressure side section and the suction side sections forming the outer wall of the at least one chordwise extending tip cooling channel.

In at least one embodiment, an intersection between the outer surfaces of the pressure side section and the suction side sections forming the inner wall of the chordwise extending tip cooling channel may be curved to form a fillet. An intersection between the outer surface of the pressure side section forming the inner wall of the chordwise extending tip cooling channel and the inner surface of the pressure side outer wall may be curved to form a fillet. Similarly, an intersection between the outer surface of the suction side section forming the inner wall of the chordwise extending tip cooling channel and the inner surface of the suction side outer wall may be curved to form a fillet. The internal cooling system may include a plurality of turbulators on the inner surface of the pressure side outer wall. The internal cooling system may also include a plurality of turbulators on the inner surface of the suction side outer wall. The internal cooling system may also include a plurality of turbulators on the inner surface of the outer wall forming at least a portion of the squealer tip.

In at least one embodiment, the inner surfaces of the pressure side section and the suction side sections forming the inner wall of the chordwise extending tip cooling channel are nonparallel and nonorthogonal relative to each other and may be aligned with the outer surfaces of the pressure side section and the suction side sections forming the inner wall of the chordwise extending tip cooling channel. The chordwise extending tip cooling channel may have one or more inlets in fluid communication with a leading edge cooling channel extending spanwise with at least a portion of the leading edge cooling channel being defined by an inner surface of an outer wall forming the leading edge of the generally elongated blade. The pressure and suction side sections forming the inner wall of the chordwise extending tip cooling channel may form at least a portion of a midchord serpentine cooling channel.

In at least one embodiment, the squealer tip may include an upstream, radially extending rib and a downstream, radially extending rib. The upstream, radially extending rib may include an upstream contact surface that is nonorthogonal and nonparallel with a longitudinal axis of the generally elongated blade such that an innermost corner of the upstream contact surface extends further upstream than an outermost corner of the upstream contact surface and includes a downstream contact surface that is nonorthogonal and nonparallel with the longitudinal axis of the generally elongated blade such that an innermost corner of the downstream contact surface extends further downstream than an outermost corner of the downstream contact surface. The downstream, radially extending rib may include a downstream contact surface that is nonorthogonal and nonparallel with a longitudinal axis of the generally elongated blade such that an innermost corner of the downstream contact surface extends further downstream than an outermost corner of the downstream contact surface and includes an upstream contact surface that is nonorthogonal and nonparallel with the longitudinal axis of the generally elongated blade such that an innermost corner of the upstream contact surface extends further upstream than an outermost corner of the upstream contact surface.

The internal cooling system may also include one or more pressure side film cooling holes positioned in the upstream, radially extending rib with an outlet in the upstream contact surface in the upstream, radially extending rib and an inlet that couples the pressure side film cooling hole with the chordwise extending tip cooling channel of the internal cooling system. The internal cooling system may also include one or more suction side film cooling holes positioned upstream of the downstream, radially extending rib with an outlet in the squealer tip between the upstream and downstream, radially extending ribs.

During use, cooling fluids may flow into the leading edge cooling channel via the inlet. The cooling fluids may flow from a cooling fluid source into the inlet of the leading edge cooling channel at an inner end of the airfoil. The cooling fluids flow through the leading edge cooling channel and are passed into the inlet of the chordwise extending tip cooling channel. The pressure and suction side sections direct the cooling fluid into contact with the inner surfaces of the pressure and suction side outer walls. By directing the cooling fluid into contact with the inner surfaces of the pressure and suction side outer walls, the cooling efficiency of the internal cooling system is enhanced. In addition, the turbulators on the inner surfaces of the pressure and suction side outer walls may further increase the efficiency of the internal cooling system. The turbulators on the inner surface of the outer wall forming at least a portion of the squealer tip may further increase the cooling of the squealer tip. The cooling fluid may be exhausted from the chordwise extending tip cooling channel via pressure and suction side film cooling holes and via the outlet proximate to the trailing edge of the airfoil. The cooling fluid exhausted via the pressure and suction side film cooling holes may be used for cooling the squealer tip.

An advantage of the internal cooling system is that the chordwise extending tip cooling channel directs cooling fluid toward the pressure and suction side outer walls for improved convection on the inner surfaces of the pressure and suction side outer walls and thereby improved cooling efficiency of the internal cooling system.

Another advantage of the internal cooling system is that the pressure and suction side sections forming the inner wall of the chordwise internal cooling system reduces the flow cross-sectional area, which accelerates the cooling fluid flow in a chordwise direction within the chordwise extending tip cooling channel and increases the cooling efficiency of the internal cooling system.

Yet another advantage of the internal cooling system is that the squealer tip has more reliable convective cooling in the squealer tip for better blade tip life and therefore lower tip leakage flow.

Another advantage of the internal cooling system is that the pressure side cooling hole is positioned in a chamfered surface enabling the cooling holes to be positioned on the surface at hot spots and for the cooling holes to have longer lengths for better cooling.

Still another advantage of this invention is that the cooling holes also provide exit film cooling at the chamfered surface, thereby reducing the temperature of the airfoil at a location that is typically a hot spot, which is an area of material having an increased temperature.

These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a partial cross-sectional, perspective view of a turbine engine with airfoils including internal cooling systems with chordwise extending tip cooling channels.

FIG. 2 is a perspective view of an airfoil with an internal cooling system having a chordwise extending tip cooling channel usable in the turbine engine shown in FIG. 1.

FIG. 3 is cross-section fillet view of the airfoil with an internal cooling system having a chordwise extending tip cooling channel taken along section line 3-3 in FIG. 2.

FIG. 4 is a partial cross-sectional view of internal cooling system having a chordwise extending tip cooling channel taken along section line 4-4 in FIG. 3.

### DETAILED DESCRIPTION OF THE INVENTION

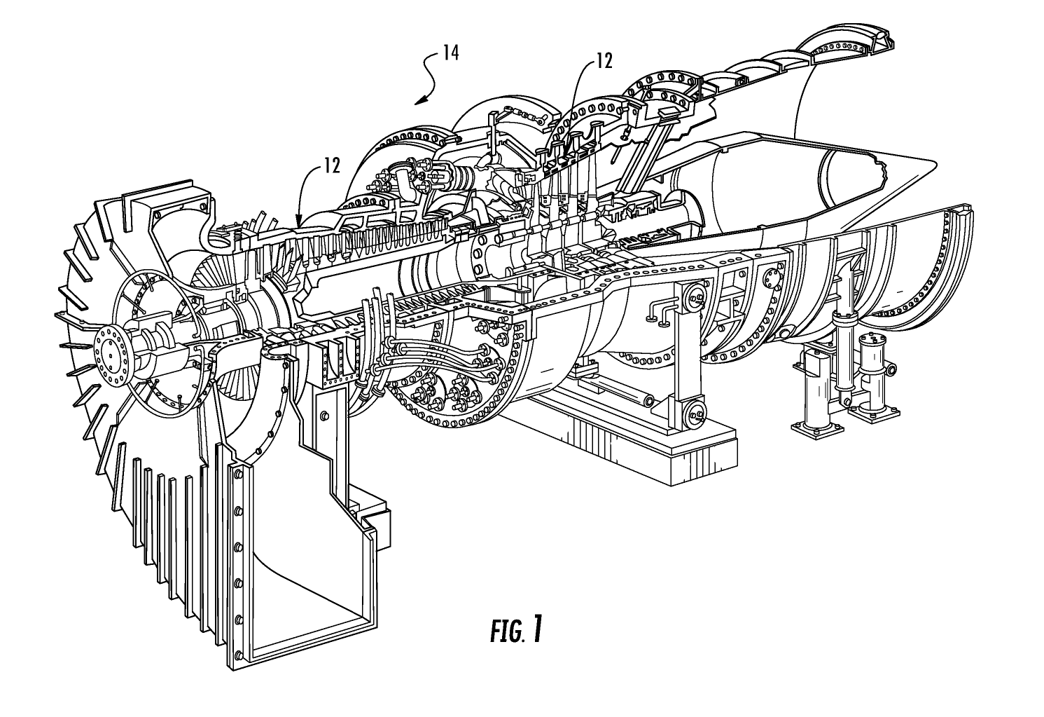

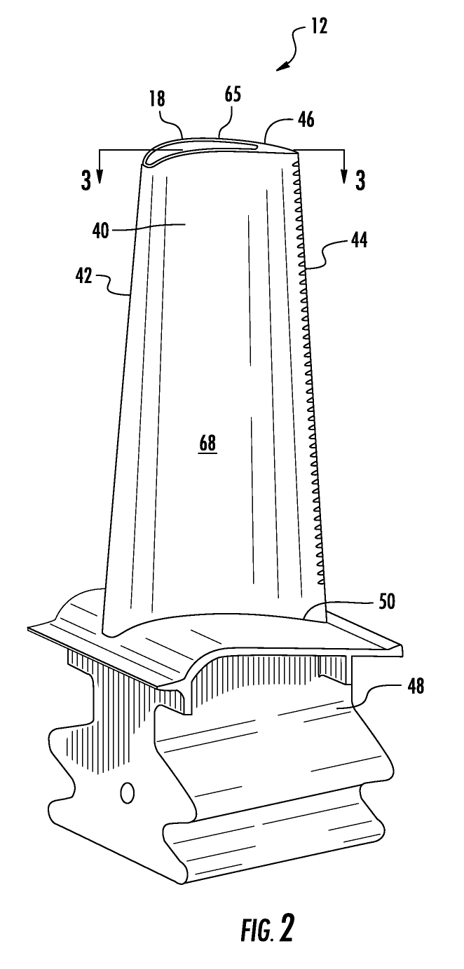

As shown in FIGS. 1-4, an internal cooling system 10 for an airfoil 12 in a turbine engine 14 whereby the cooling system 10 includes a chordwise extending tip cooling channel 16 radially inward of a squealer tip 18 and formed at least in part by an inner wall 20 with a nonlinear outer surface 22 is disclosed. The nonlinear outer surface 22 of the inner wall 20 of the chordwise extending tip cooling channel 16 may be formed from pressure and suction side sections 24, 26 that intersect at a point 28 that is closer to an inner surface 30 of an outer wall 32 forming at least a portion of the squealer tip 18 than other aspects of the pressure side section 24 and the suction side sections 26. The configurations of the pressure and suction side sections 24, 26 reduces the flow cross-sectional area, which accelerates the cooling fluid flow in a chordwise direction within the chordwise extending tip cooling channel 16 and directs cooling fluid toward the pressure and suction side outer walls 34, 36 for improved cooling efficiency.

In at least one embodiment, the turbine airfoil 12 may be formed from a generally elongated blade 40 having a leading edge 42, a trailing edge 44, a squealer tip 18 at a first end 46, a root 48 coupled to the blade 40 at a second end 50 generally opposite the first end 46 for supporting the blade 40 and for coupling the blade 40 to a disc, and an internal cooling system 10 formed from at least one cavity 52 positioned within the generally elongated blade 40. The internal cooling system 10 may include one or more chordwise extending tip cooling channels 16 formed at least in part by an inner surface 30 of an outer wall 32 forming at least a portion of the squealer tip 18. The chordwise extending tip cooling channel 16 may include an inner wall 20 formed from a pressure side section 24 that has an outer surface 54 that is nonparallel and nonorthogonal to the inner surface 58 of the pressure side outer wall 34. The outer surface 54 of the pressure side section 24 may be positioned between 30 degrees and 75 degrees relative to the inner surface 58 of the pressure side outer wall 34. The chordwise extending tip cooling channel 16 may also include a suction side section 26 that has an outer surface 56 that is nonparallel and nonorthogonal to an inner surface 60 of a suction side outer wall 36. The outer surface 56 of the suction side section 26 may be positioned between 30 degrees and 75 degrees relative to the inner surface 60 of the suction side outer wall 36. The outer surfaces 54, 56 of the pressure side section 24 and the suction side section 26 forming the inner wall 20 of the chordwise extending tip cooling channel 16 may be nonparallel and nonorthogonal relative to each other. In at least one embodiment, the outer surfaces 54, 56 of the pressure side section 24 and the suction side section 26 extend for at least a portion of the inner wall 20 of the chordwise extending tip cooling channel 16. In at least one embodiment, the pressure and suction side sections 24, 26 may extend for an entirety of the inner wall 20 of the chordwise extending tip cooling channel 16.

The pressure side section 24 and the suction side section 26 may intersect at the point 28. The intersection 28 between the outer surfaces 54, 56 of the pressure side section 24 and the suction side section 26 forming the inner wall 20 of the chordwise extending tip cooling channel 16 is closer to the inner surface 30 of the outer wall 32 forming at least a portion of the squealer tip 18 than other aspects of the pressure side section 24 and the suction side section 26 forming the outer wall 32 of the chordwise extending tip cooling channel 16. The intersection 28 between the outer surfaces 54 of the pressure side section 24 and the suction side section 26 forming the inner wall 20 of the chordwise extending tip cooling channel 16 may be curved to form a fillet. An intersection 62 between the outer surface 54 of the pressure side section 24 forming the inner wall 20 of the chordwise extending tip cooling channel 16 and the inner surface 58 of the pressure side outer wall 34 may be curved to form a fillet or have another appropriate configuration. An intersection 64 between the outer surface 56 of the suction side section 26 forming the inner wall 20 of the chordwise extending tip cooling channel 16 and the inner surface 60 of the suction side outer wall 36 may be curved to form a fillet or have another appropriate configuration.

The internal cooling system 10 may include other elements to enhance the cooling capacity and efficiency. In at least one embodiment, the internal cooling system 10 may include a plurality of turbulators 66 on the inner surface 58 of the pressure side outer wall 34. The turbulators 66 may extend from the inner surface 58 of the pressure side outer wall 34 toward the suction side 65. The internal cooling system 10 may include a plurality of turbulators 66 on the inner surface 60 of the suction side outer wall 36. The turbulators 66 may extend from the inner surface 60 of the suction side outer wall 36 toward the pressure side 68. One or more turbulators 66 may extend on the inner surface 30 of the outer wall 32 forming at least a portion of the squealer tip 18.

The inner surfaces 70, 72 of the pressure side section 24 and the suction side section 26 forming the inner wall 20 of the chordwise extending tip cooling channel 16 may be nonparallel and nonorthogonal relative to each other and may be aligned with the outer surface 54, 56 of the pressure side and the suction side sections 24, 26 forming the inner wall 20 of the chordwise extending tip cooling channel 16. An intersection 74 between the inner surfaces 70, 72 of the pressure and suction side sections 24, 26 is curved to form a fillet. Wherein an intersection 76 between the inner surface 70 of the pressure side section 24 and the inner surface 58 of the pressure side outer wall 34 is curved to form a fillet. Wherein an intersection 78 between the inner surface 72 of the suction side section 26 and the inner surface 60 of the suction side outer wall 36 is curved to form a fillet.

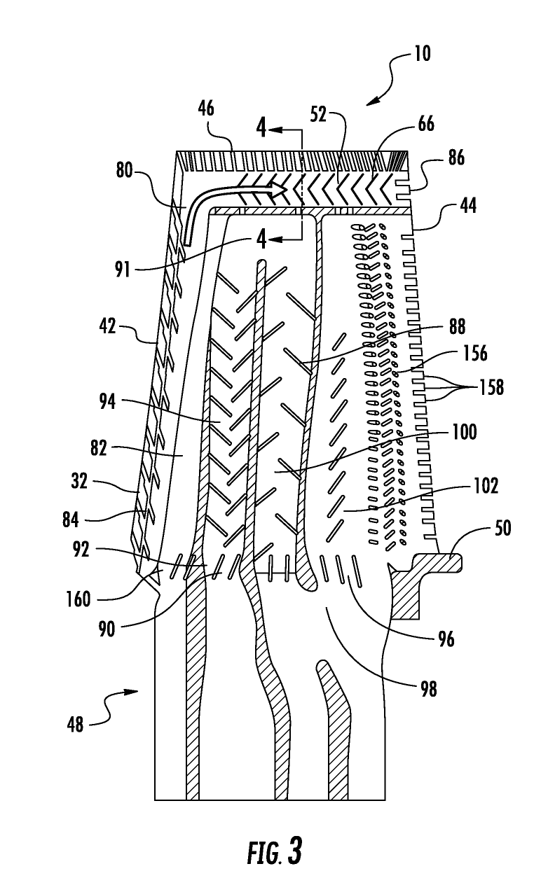

In at least one embodiment, as shown in FIG. 3, the chordwise extending tip cooling channel 16 may have one or more inlets 80 in fluid communication with a leading edge cooling channel 82 extending spanwise with at least a portion of the leading edge cooling channel 82 being defined by an inner surface 84 of an outer wall 32 forming the leading edge 42 of the generally elongated blade 40. In at least one embodiment, the chordwise extending tip cooling channel 16 may include an inlet 80 proximate to the leading edge 42 of the airfoil 12 and may include an outlet 86 proximate to the trailing edge 44 of the airfoil 12. The leading edge cooling channel 82 may include an inlet 160 at an inner end 50 of the airfoil 12 that is in communication with a cooling fluid source.

The pressure and suction side sections 24, 26 forming the inner wall 20 of the chordwise extending tip cooling channel 16 may form at least a portion of a midchord serpentine cooling channel 88. The midchord serpentine cooling channel 88 may be a triple pass serpentine cooling channel. The midchord serpentine cooling channel 88 may have a first inlet 90 at an inner end 92 of the a first leg 94 of the midchord serpentine cooling channel 88. In at least one embodiment, the midchord serpentine cooling channel 88 may include a second inlet 96 at a second turn 98, which is an inner turn between the second and third legs 100, 102 of the midchord serpentine cooling channel 88. Cooling fluid may enter the first leg 94 via first inlet 90, flow through first turn 91 and into the second leg 100. The cooling fluid may flow from the second leg 100, through second turn 98 and into the third leg 102. As the cooling fluid is flowing into the third leg 102, additional cooling fluid from the second inlet 96 is added to the cooling fluid flow into the third leg 102. Cooling fluid in the third leg 102 may flow into a trailing edge cooling channel 156 and may be exhausted through one or more trailing edge exhaust orifices 158 in the trailing edge 44.

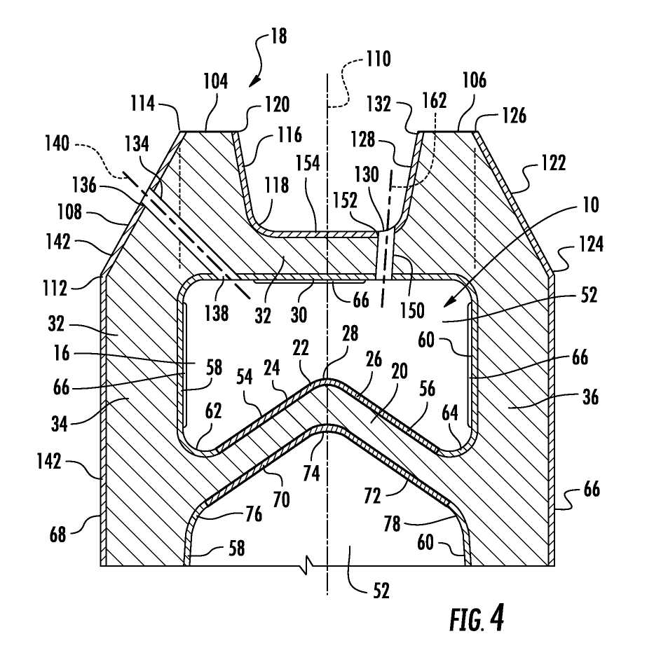

The squealer tip 18 may have any appropriate configuration. In at least one embodiment, as shown in FIG. 4, the squealer tip 18 may include an upstream, radially extending rib 104 and a downstream, radially extending rib 106. The upstream, radially extending rib 104 may include an upstream contact surface 108 that is nonorthogonal and nonparallel with a longitudinal axis 110 of the generally elongated blade 40 such that an innermost corner 112 of the upstream contact surface 108 extends further upstream than an outermost corner 114 of the upstream contact surface 108. The upstream, radially extending rib 104 may also include a downstream contact surface 116 that is nonorthogonal and nonparallel with the longitudinal axis 110 of the generally elongated blade 40 such that an innermost corner 118 of the downstream contact surface 116 extends further downstream than an outermost corner 120 of the downstream contact surface 116. The downstream, radially extending rib 106 may include a downstream contact surface 122 that is nonorthogonal and nonparallel with a longitudinal axis 110 of the generally elongated blade 40 such that an innermost corner 124 of the downstream contact surface 122 extends further downstream than an outermost corner 126 of the downstream contact surface 122. The downstream, radially extending rib 106 may also include an upstream contact surface 128 that is nonorthogonal and nonparallel with the longitudinal axis 110 of the generally elongated blade 40 such that an innermost corner 130 of the upstream contact surface 128 extends further upstream than an outermost corner 132 of the upstream contact surface 128.

The internal cooling system 10 may also include one or more pressure side film cooling holes 134 positioned in the upstream, radially extending rib 104 with an outlet 136 in the upstream contact surface 108 in the upstream, radially extending rib 104 and an inlet 138 that couples the pressure side film cooling hole 134 with the chordwise extending tip cooling channel 16 of the internal cooling system 10. The pressure side film cooling hole 134 may have a longitudinal axis 140 that is positioned nonparallel and nonlinear to the outer surface 142 forming the pressure side 68 of the airfoil 12. The internal cooling system 10 may also include one or more suction side film cooling holes 150 positioned upstream of the downstream, radially extending rib 106 with an outlet 152 in the squealer tip 18 between the upstream and downstream, radially extending ribs 104, 106. The suction side film cooling hole 150 may have a longitudinal axis 162 that is positioned nonparallel and nonlinear to the outer surface 154 of the squealer tip 18 between the upstream and downstream, radially extending ribs 104, 106 such that cooling fluid is exhausted from the suction side film cooling hole 150 with at least a partial downstream vector.

During use, cooling fluids may flow into the leading edge cooling channel 82 via the inlet 80. The cooling fluids may flow from a cooling fluid source into the inlet 160 of the leading edge cooling channel 82 at an inner end 50 of the airfoil 12. The cooling fluids flow through the leading edge cooling channel 82 and are passed into the inlet 80 of the chordwise extending tip cooling channel 16. The pressure and suction side sections 24, 26 direct the cooling fluid into contact with the inner surfaces 58, 60 of the pressure and suction side outer walls 34, 36. By directing the cooling fluid into contact with the inner surfaces 58, 60 of the pressure and suction side outer walls 34, 36, the cooling efficiency of the internal cooling system 10 is enhanced. In addition, the turbulators 66 on the inner surfaces 58, 60 of the pressure and suction side outer walls 34, 36 may further increase the efficiency of the internal cooling system 10. The cooling fluid may be exhausted from the chordwise extending tip cooling channel 16 via pressure and suction side film cooling holes 134, 150 and via the outlet 86 proximate to the trailing edge 44 of the airfoil 12. The cooling fluid exhausted via the pressure and suction side film cooling holes 134, 150 may be used for cooling the squealer tip 18.

The foregoing is provided for purposes of illustrating, explaining, and describing embodiments of this invention. Modifications and adaptations to these embodiments will be apparent to those skilled in the art and may be made without departing from the scope or spirit of this invention.

1. A turbine airfoil comprising:
a generally elongated blade having a leading edge, a trailing edge, a squealer tip at a first end, a root coupled to the blade at a second end generally opposite the first end for supporting the blade and for coupling the blade to a disc, and an internal cooling system formed from at least one cavity positioned within the generally elongated blade;
wherein the internal cooling system comprises at least one chordwise extending tip cooling channel formed at least in part by an inner surface of an outer wall forming at least a portion of the squealer tip;
wherein the at least one chordwise extending tip cooling channel includes an inner wall formed from a pressure side section that has an outer surface that is nonparallel and nonorthogonal to an inner surface of a pressure side outer wall, and a suction side section that has an outer surface that is nonparallel and nonorthogonal to an inner surface of a suction side outer wall; and
wherein the outer surfaces of the pressure side section and the suction side section forming the inner wall of the at least one chordwise extending tip cooling channel are nonparallel and nonorthogonal relative to each other.

2. The turbine airfoil of claim 1, wherein an intersection between the outer surfaces of the pressure side section and the suction side section forming the inner wall of the at least one chordwise extending tip cooling channel is closer to the inner surface of an outer wall forming at least a portion of the squealer tip than other aspects of the pressure side section and the suction side section forming the outer wall of the at least one chordwise extending tip cooling channel.

3. The turbine airfoil of claim 1, wherein an intersection between the outer surfaces of the pressure side section and the suction side section forming the inner wall of the at least one chordwise extending tip cooling channel is curved to form a fillet.

4. The turbine airfoil of claim 1, wherein an intersection between the outer surface of the pressure side section forming the inner wall of the at least one chordwise extending tip cooling channel and the inner surface of the pressure side outer wall is curved to form a fillet.

5. The turbine airfoil of claim 1, wherein an intersection between the outer surface of the suction side section forming the inner wall of the at least one chordwise extending tip cooling channel and the inner surface of the suction side outer wall is curved to form a fillet.

6. The turbine airfoil of claim 1, further comprising a plurality of turbulators on the inner surface of the pressure side outer wall.

7. The turbine airfoil of claim 1, further comprising a plurality of turbulators on the inner surface of the suction side outer wall.

8. The turbine airfoil of claim 1, wherein inner surfaces of the pressure side section and the suction side section forming the inner wall of the at least one chordwise extending tip cooling channel are nonparallel and nonorthogonal relative to each other and are aligned with the outer surfaces of the pressure side section and the suction side section forming the inner wall of the at least one chordwise extending tip cooling channel.

9. The turbine airfoil of claim 1, wherein the at least one chordwise extending tip cooling channel has at least one inlet in fluid communication with a leading edge cooling channel extending spanwise with at least a portion of the leading edge cooling channel being defined by an inner surface of an outer wall forming the leading edge of the generally elongated blade.

10. The turbine airfoil of claim 1, wherein the pressure and suction side section forming the inner wall of the at least one chordwise extending tip cooling channel form at least a portion of a midchord serpentine cooling channel.

11. The turbine airfoil of claim 1, wherein the squealer tip comprises an upstream, radially extending rib and a downstream, radially extending rib, wherein the upstream, radially extending rib includes an upstream contact surface that is nonorthogonal and nonparallel with a longitudinal axis of the generally elongated blade such that an innermost corner of the upstream contact surface extends further upstream than an outermost corner of the upstream contact surface and includes a downstream contact surface that is nonorthogonal and nonparallel with the longitudinal axis of the generally elongated blade such that an innermost corner of the downstream contact surface extends further downstream than an outermost corner of the downstream contact surface and wherein the downstream, radially extending rib includes a downstream contact surface that is nonorthogonal and nonparallel with a longitudinal axis of the generally elongated blade such that an innermost corner of the downstream contact surface extends further downstream than an outermost corner of the downstream contact surface and includes an upstream contact surface that is nonorthogonal and nonparallel with the longitudinal axis of the generally elongated blade such that an innermost corner of the upstream contact surface extends further upstream than an outermost corner of the upstream contact surface.

12. The turbine airfoil of claim 1, wherein at least one pressure side film cooling hole is positioned in the upstream, radially extending rib with an outlet in the upstream contact surface in the upstream, radially extending rib and an inlet that couples the at least one pressure side film cooling hole with the at least one chordwise extending tip cooling channel of the internal cooling system.

13. The turbine airfoil of claim 1, wherein at least one suction side film cooling hole is positioned upstream of the downstream, radially extending rib with an outlet in the squealer tip between the upstream and downstream, radially extending ribs.
